(19) United States
(12) Patent Application Publication
(10) Pub. No.: US 2025/0010782 A1
(43) Pub. Date: Jan. 9, 2025

(54) FOLDING TABLE SYSTEM FOR A VEHICLE SEAT

(71) Applicant: ZF AUTOMOTIVE GERMANY GMBH, Alfdorf (DE)

(72) Inventors: Dennis BOTTA, Konigstein (DE); Antonia FISCHER, Puchheim (DE); Georg MATICS, Donzdorf (DE); Lukas G¿SSL, Rutesheim (DE); Jan MARTINOV, Neidlingen (DE); Cedric ZIMMERMANN, Villingen-Schwenningen (DE)

(21) Appl. No.: 18/689,578

(22) PCT Filed: Sep. 6, 2022
(86) PCT No.: PCT/EP2022/074761

§ 371 Date: Mar. 6, 2024

(30) Foreign Application Priority Data
Sep. 7, 2021 (DE) 10 2021 123 145.0

(51) Int. Cl. B60N 3/00; B60N 2/75; B60R 11/02; B60R 21/20

(52) U.S. Cl. CPC B60N 3/002; B60N 2/793; B60R 11/0229; B60R 21/20; B60R 2011/0276

(57) ABSTRACT

A hinged table system (10) for a vehicle seat (12) comprises a passenger module (14) and a holding and adjusting device, wherein the passenger module (14) comprises an airbag and a tabletop (20) including a multimedia panel (32), and the airbag is in fluid communication with an inflator so that the inflator can inflate the airbag, and wherein the passenger module (14) is coupled to the holding and adjusting device and can be adjusted between an operating position in front of an associated vehicle occupant sitting in the vehicle seat (12) and a storing position.

### TECHNICAL FIELD

The invention relates to a hinged table system for a vehicle seat comprising a passenger module, a holding and adjusting device and a separate storage chamber, wherein the passenger module comprises at least an airbag and a tabletop including a multimedia panel, and the airbag is in fluid communication with an inflator so that the inflator can inflate the airbag.

### BACKGROUND

Hinged table systems for vehicle seats are known in which a passenger module is coupled to the vehicle seat via a mounting arm and can be adjusted between a storing position and an operating position. It is the drawback of the known hinged table systems that the passenger module in the rest position is felt to be disturbing by vehicle occupants or a particularly complex adjusting device is required to adjust the passenger module between the rest position and the use position.

### SUMMARY

It is the object of the invention to provide a hinged table system for a vehicle seat which can be adjusted particularly easily and can be advantageously stored.

The object is achieved by a hinged table system for a vehicle seat comprising a passenger module, a holding and adjusting device and a separate storage chamber, wherein the passenger module comprises at least an airbag and a tabletop including a multimedia panel, and the airbag is in fluid communication with an inflator so that the inflator can inflate the airbag. The passenger module is coupled to the holding and adjusting device and can be adjusted between an operating position in front of an associated vehicle occupant in the vehicle seat and a storing position in the storage chamber. If the vehicle module comprises two or more airbags, as a matter of fact, each airbag can be in fluid communication with a separate inflator or individual one of the inflators are in fluid communication with a respective airbag, whereas further inflators are in fluid communication with two or more further airbags.

The invention is based on the fundamental idea that the passenger module is stored in the storing position in a particularly simple manner in an already existing vehicle component so that it requires no additional space in the storing position. In addition, this results in the fact that adjusting the passenger module and the passenger module in the storing position will not be felt to be disturbing by a vehicle occupant, which improves the vehicle comfort.

Preferably, the storage chamber includes a door adapted to be opened and closed. In this way, the storage chamber can be easily integrated in an already existing component.

In one embodiment of the invention, an operating panel for controlling the holding and adjusting device is disposed in a center console. Thus, a vehicle occupant can electrically operate the hinged table system in a convenient and simple manner.

The holding and adjusting device can be provided to include a linear rail for vertically and/or horizontally guiding the movement. In this way, guiding the movement of the holding and adjusting device can be realized in a particularly simple and safe manner.

In one configuration of the invention, the adjusting device has a lifting mechanism with a spindle drive for vertically moving the passenger module. Thus, a simple, robust and particularly compact drive for the vertical movement of the passenger module is provided.

Preferably, the adjusting device includes a rotation unit so that the passenger module can be pivoted about an axis of rotation. Thus, the passenger module can be adjusted and adapted about its axis of rotation as required by the vehicle occupant.

In one embodiment, the storage chamber is formed in the center console. This offers the advantage that the adjusting distance from the storing position to the operating position is particularly short. As a result, one can change more quickly between the positions. In addition, when the storage chamber is closed, the center console can further be used by the vehicle occupants as an oddments tray or armrest, for example.

In one configuration variant, the storage chamber is disposed between two backrests. In this way, the passenger module can be stored particularly conveniently for the occupants in a sitting in a rear bench seat.

The object is further achieved by a hinged table system for a vehicle seat comprising a passenger module and a holding and adjusting device, wherein the passenger module comprises at least an airbag and a tabletop including a multimedia panel, and the airbag is in fluid communication with an inflator so that the inflator can inflate the airbag. The passenger module is coupled to the holding and adjusting device, and the holding and adjusting device includes a guide rail associated with the vehicle seat to predetermine an adjusting path for the passenger module, wherein the passenger module can be adjusted between an operating position in front of a vehicle occupant and a storing position on a backrest of the vehicle seat on the predetermined adjusting path.

The above discussed advantages are also applicable to such hinged table system.

Preferably, the holding and adjusting device includes a lifting column for vertically moving the passenger module. The passenger module can thus be easily height-adjusted.

In one embodiment of the invention, the holding and adjusting device includes, for example, a U-shaped carriage which is slidably disposed on the guide rail, with the lifting column being mounted on the carriage. A particularly simple and compact design is realized in this way. As a matter of course, the carriage and the guide rail of the holding and adjusting device can also have alternative designs which allow to guide the movement in the desired, specifically linear, manner. By way of example only, a dovetail guide or a firtree guide are mentioned here.

The holding and adjusting device preferably comprises a joint for rotationally moving the passenger module. This helps pivot the passenger module about an axis of rotation and simply fold it away from the vehicle occupant when it is adjusted into the storing position.

The guide rail can be provided to be mounted in a lower portion of a seat base of the vehicle seat (the seat base is the vertical part of the seat on which the occupant's bottom rests). Thus, the passenger module is adjusted in a portion remote from the vehicle occupant, which does not disturb the vehicle occupant.

In one embodiment of the invention, the guide rail extends from one side of the vehicle seat to the rear of the vehicle seat while describing a 90° curve. Thus, an adjusting path from the operating position to the storing position which can be manufactured particularly easily is predetermined.

Preferably, the passenger module in the storing position is arranged on the backrest of the vehicle seat so that the multimedia panel can be used as a screen by passengers sitting in a rear bench seat with a viewing direction to the backrest. In this way, the passenger module can fulfil a function even in the storing position.

The passenger module can be provided to be arranged, in the storing position, in a holder in the backrest or to form a part of the backrest. Therefore, the passenger module requires no additional space which would reduce, e.g., the leg room of the vehicle occupants in the rear bench seat.

Preferably, the hinged table system includes a module holder arranged on the vehicle seat, wherein the passenger module on one side transversely to the longitudinal extension of the seat is coupled to the holding and adjusting device and on the opposite side in the operating position is releasably locked on the vehicle side. The passenger module thus can be mounted particularly stably on the vehicle seat, as it is fastened to both opposite ends at the seat side and a closed arch is formed around the abdominal area of the occupant, which improves the support of the airbag.

In one embodiment of the invention, the module holder is formed at an armrest of the vehicle seat. This helps design the connection between the passenger module and the module holder in a specifically simple and ergonomic manner.

The adjusting device can be provided to include a drive for moving the passenger module fully automatically so that the passenger module can be adjusted easily and conveniently. The drive is particularly an electric drive having one or more motors. In addition, the passenger module can be provided to be adjusted by the fully automatic adjusting device via a control unit of a vehicle occupant protection system in a pre-crash situation from the operating position to a restraining position provided for restraining the vehicle occupant. In the restraining position, the passenger module has a distance from the vehicle occupant in which the airbags disposed in the passenger modules ensure most optimum restraint of the vehicle occupant. The distance of the passenger module from the occupant in the vehicle seat during adjustment into the restraining position can be determined, for example, using the data of sensors disposed in the passenger module.

In one configuration variant of the invention, the passenger module is covered at least partly with an LED material. In this way, additionally to the multimedia panel, information from the LED material can further be provided. In addition, the LED material can also serve as a touchpad for operating the passenger module. Alternatively, instead of the LED material, also an operating and display material can be utilized which applies an imaging and/or displaying technology different from the LED technology.

### BRIEF DESCRIPTION OF THE DRAWINGS

Further features and advantages of the invention will be evident from the following description and from the attached drawings which are referred to, and wherein:

FIG. 1 shows a perspective view of a first embodiment of a hinged table system according to the invention comprising a storage chamber,

FIG. 2 shows another perspective view of the hinged table system of FIG. 1,

FIG. 3 shows a perspective individual view of a holding and adjusting device according to the invention of the hinged table system of FIG. 1,

FIG. 4 shows a perspective view of the hinged table system of FIG. 1, with the passenger module being adjusted,

FIG. 5 shows a perspective view of the hinged table system of FIG. 1 which is mounted in a vehicle,

FIG. 6 shows a top view of the hinged table system of FIG. 1 in another vehicle,

FIG. 7 shows a perspective detail view of a module holder according to the invention on an armrest,

FIG. 8 shows a perspective detail view of a locking button on a tabletop,

FIG. 9 shows a lateral view of a detail of the passenger module and a module holder of a hinged table system according to the invention,

FIG. 10 shows a perspective view of a passenger module including LED material which is usable for the invention,

FIGS. 11A to 11E show a second embodiment of a hinged table system according to the invention including a storage chamber in different positions of the passenger module,

FIG. 12 shows a third embodiment of a hinged table system according to the invention including a guide rail in different positions of the passenger module,

FIG. 13 shows a detail view of the holding and adjusting device of the hinged table system of FIG. 12,

FIG. 14 shows a lateral view of the hinged table system of FIG. 12,

FIG. 15 shows a rear view of the hinged table system of FIG. 12,

FIG. 16 shows a top view of the hinged table system of FIG. 12,

FIG. 17 shows a perspective view of the hinged table system of FIG. 12,

FIG. 18 shows a perspective view of a first alternative hinged table system in a vehicle in the storing position,

FIG. 19 shows a perspective view of the hinged table system of FIG. 18 in the operating position,

FIG. 20 shows a lateral view of the hinged table system of FIG. 18, with the passenger module being adjusted out of the storing position, in different positions of the passenger module,

FIG. 21 shows a lateral view of the hinged table system of FIG. 18, with the passenger module being adjusted into the operating position, in different positions of the passenger module,

FIG. 22 shows a lateral view of a second alternative hinged table system, and

FIG. 23 shows a lateral view of the hinged table system of FIG. 22 with the vehicle seat being rotated.

### DESCRIPTION

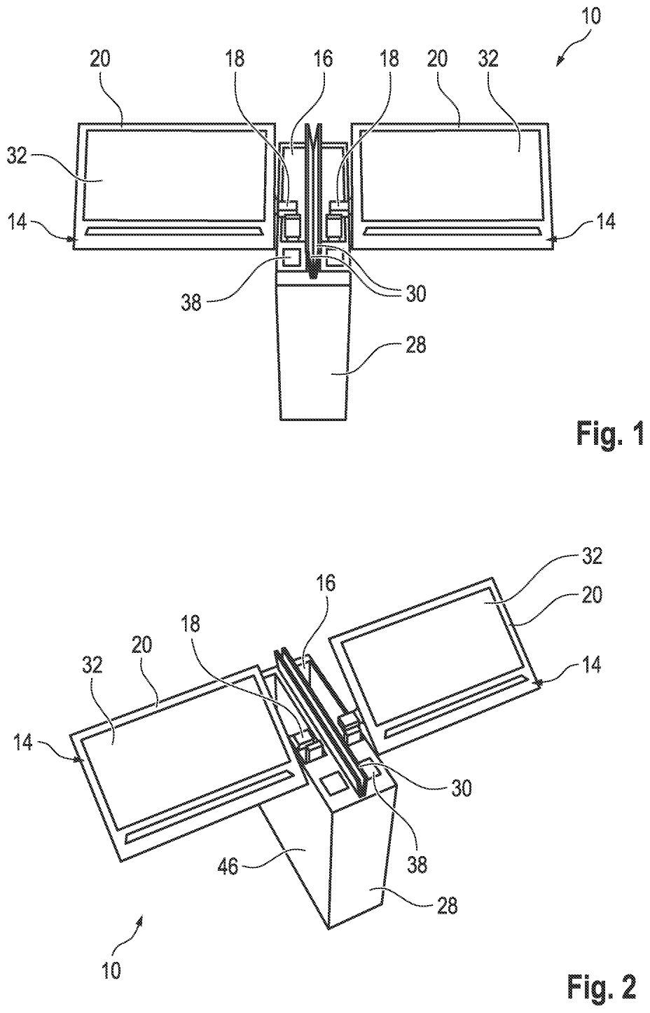

FIGS. 1 to 6 illustrate a first embodiment of a hinged table system according to the invention for a vehicle seat 12 comprising two passenger modules 14, a separate storage chamber 16 and a holding and adjusting device 18 for each passenger module 14.

The passenger module 14 can be adjusted by its holding and adjusting device 18 between an operating position and a storing position.

The operating position is substantially identical for the different embodiments, while the storing position may vary.

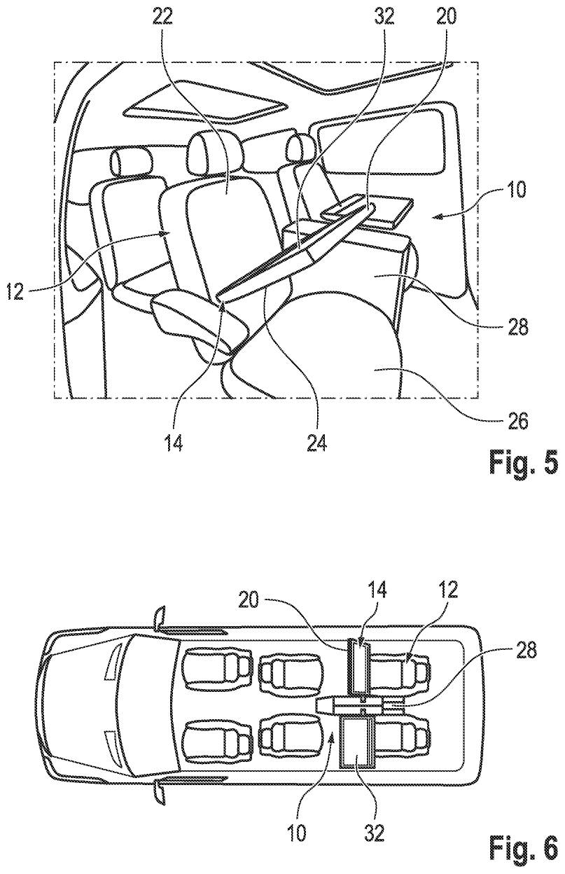

In the operating position, see FIG. 5, a tabletop 20 of the passenger module 14 extends in front of a vehicle occupant so that the vehicle occupant's upper torso is disposed between the tabletop 20 and a backrest 22 of the vehicle seat 12, and the vehicle occupant's thighs are located between the lower side 24 of the tabletop 20 and a seat base 26 of the vehicle seat 12.

The tabletop 20 can be aligned, in the operating position, substantially horizontally, i.e. in parallel to an X-Y plane, and/or substantially in parallel to the seat base 26 so that the vehicle occupant can use the tabletop 20 as a table or tray.

Where needed, the tabletop 20 can be pivoted about a horizontal axis so that it is aligned at an angle with the X-Y plane (horizontal plane) and/or the seat base 26.

In the embodiment according to FIGS. 1 to 6, the storage chamber 16 is formed in a center console 28 and includes a door 30 (see FIG. 4) by which the storage chamber 16 can be opened and closed.

In the illustrated embodiment, the storage chamber 16 has a substantially rectangular cross-section. The storage chamber 16 may also have other cross-sections. Accordingly, the storage chamber 16 is adapted to the design of the passenger module 14. If the tabletop 20 of the passenger module 14 has a complex shape such as in FIG. 10, the storage chamber 16 exhibits a corresponding contour.

The left and right parts of the hinged table system 10 are designed identically. Therefore, such a hinged table system 10 can be installed, e.g., in the center console 28 between a driver and a passenger in a front seat row, but also in center consoles 28 of the back seat rows (FIGS. 5 and 6).

The passenger module 14 comprises the tabletop 20 into which a multimedia panel 32 is integrated, a schematically illustrated airbag 34 and a schematically illustrated inflator 36 which is in fluid communication with and can inflate the airbag 34 (FIG. 4). The airbag 34 and the inflator 36 are disposed inside the tabletop 20, and the airbag 34, when inflated, can expand, for example, through openings or doors out of the tabletop 20 or the tabletop 20 can tear.

The airbag 34, when inflated, serves as restraining element for the vehicle occupant. It is also imaginable in this context that the passenger module 14 includes plural inflatable airbags 34, wherein, e.g., a first airbag 34 can serve as a lap restraint and a further airbag serves as an impact protection for the vehicle occupant's head. Accordingly, one or more airbags can be in fluid communication with an inflator. For example, both the first airbag 34 and the further airbag can be connected to the same inflator 36 or to respective separate inflators.

The tabletop 20 has an ergonomic design and includes edges rounded on the sides. On the lower side 24 of the tabletop 20, viz. on the surface formed on the opposite side of the multimedia panel 32 and facing the seat base 26, radii are formed so that the vehicle occupant does not get caught if his/her legs come into contact with the tabletop 20. Moreover, the vehicle occupant can use the tabletop 20 as a tray or armrest, for example.

The multimedia panel 32 can be, e.g., a screen or touchscreen and can provide the vehicle occupant with driving information.

On the center console 28, for example an operating panel 38 is disposed (see FIG. 2) by which the holding and adjusting device 18 can be operated and, thus, the passenger module 14 can be adjusted.

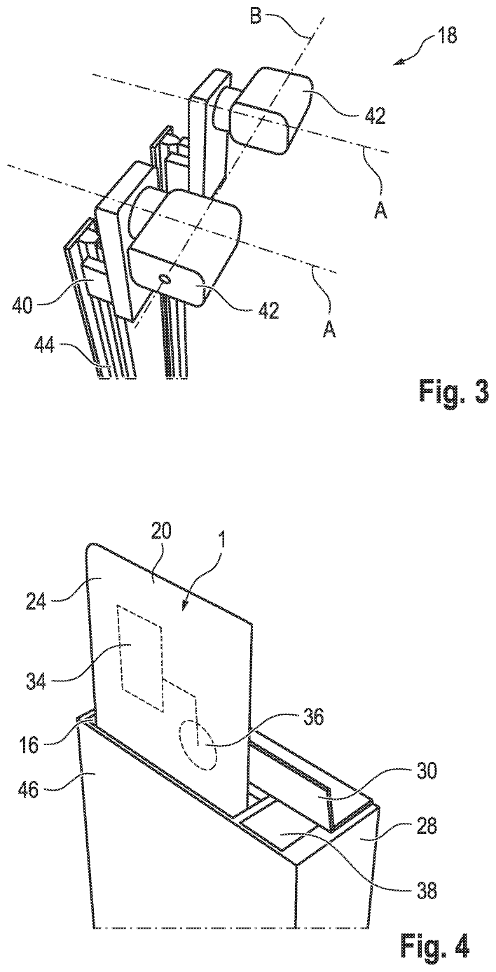

In the shown embodiment, the holding and adjusting device 18 comprises a lifting mechanism with a spindle drive 40 and a rotation unit 42 by which the passenger module 14 can be adjusted between the storing position in the storage chamber 16 and the operating position in front of the vehicle occupant (FIG. 3).

The spindle drive 40 is arranged on a linear rail 44 and can be vertically adjusted. The rotation unit 42 by which the passenger module 14 can be pivoted about an axis of rotation A so that the surface of the tabletop 20 including the multimedia panel 32 can be aligned in parallel to the lateral face 46 of the center console 28 is mounted on the spindle drive 40 (FIG. 4).

The passenger module 14 is mounted pivotably on the rotation unit 42 and thus can be pivoted by the rotation unit 42 additionally about an axis of rotation B. The vehicle occupant can thus align the tabletop 20 in the operating position in front of them at the desired angle. For example, FIG. 5 reveals that one tabletop 20 is aligned approximately in parallel to the seat base 26, while the other table top 20 shows an angle of about 45° with the seat base 26.

In the illustrated embodiment, in the storing position the passenger module 14 is accommodated completely in the storage chamber 16 and the door 30 of the storage chamber 16 is closed so that in the storing position the passenger module 14 is not visible to the vehicle occupant (right side of FIG. 4).

In the storage chamber 16, the short sides of the tabletop 20 face upwards and downwards, respectively, and the surface including the multimedia panel 32 is aligned in parallel to the lateral face 46 of the center console 28. Accordingly, the lower side 24 faces the vehicle occupant. In other words, the storage chamber 16 is vertically aligned and the door 30 is located on the upper side of the center console 28 next to the opening of the storage chamber 16.

The door 30, when closed, covers both the opening of the storage chamber 16 and the operating panel 38 so that the center console 28 can be used as an armrest or tray, for example, without the operating panel 38 being damaged or operated inadvertently.

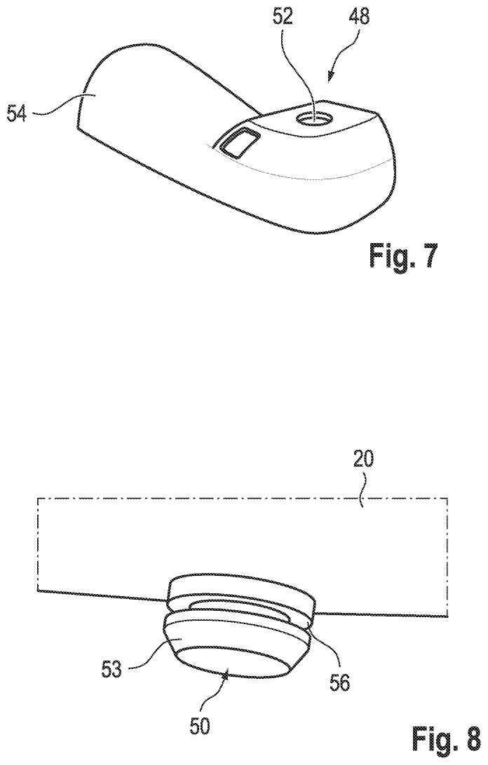

The passenger module 14 can be coupled, in the operating position, on one side transversely to the longitudinal extension of the seat to the holding and adjusting device 18 and on the opposite side to a module holder 48 (FIGS. 7 and 8), which results in a mechanically closed support encircling the occupant's abdomen.

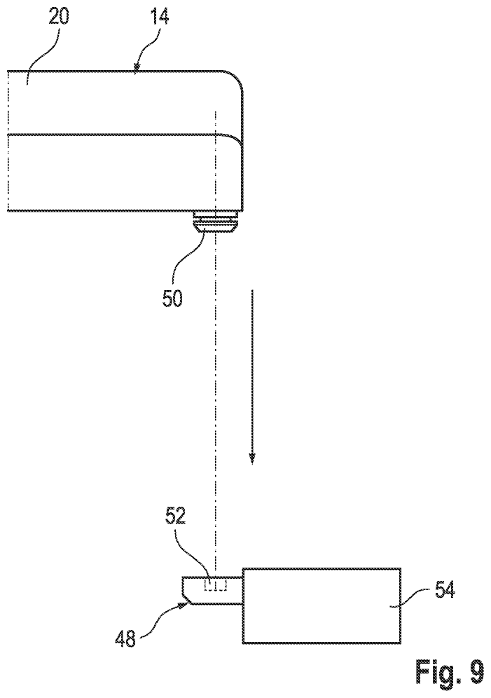

The passenger module 14 can have a locking button 50 (see FIG. 8) which is formed e.g. on the lower side 24 of the tabletop 20. The locking button 50 engages releasably in a corresponding opening 52 in the module holder 48 (see FIG. 9) so that the passenger module 14 is held stable in the operating position. It is also conceivable that the locking button 50 is arranged on the tabletop 20 so that, even when it has engaged in the module holder 48, rotation of the tabletop 20 about the axis of rotation B is possible.

The locking button 50 in the shown embodiment has a round basic shape, an insertion slope 53 and a locking groove 56.

The module holder 48 can be formed, e.g., on an armrest 54 which is located on the vehicle seat 12. It is also conceivable, however, that the module holder 48 is formed on a door part or on a different part of the vehicle seat 12.

Moreover, parts of the tabletop 20 which have no multimedia panel 32 can be provided to be coated with an LED material 60. The LED material 60 can serve, for example, as an additional touchpad and/or can provide the vehicle occupant with additional information (FIG. 10). Instead of the LED material 60, also an operating and display material or an operating and display surface can be used which utilizes image and/or display forming technology different from the LED technology.

The multimedia panel 32 in the shown embodiment according to FIG. 10 is arranged on the tabletop 20 so that it can be slid out of and into the tabletop 20 as needed.

In the following, the adjustment of the passenger module 14 comprising the hinged table system 10 according to FIGS. 1 to 6 between the storing position and the operating position shall be explained.

When the vehicle occupant takes a seat in the vehicle seat 12, the hinged table system 10 is automatically activated, and the holding and adjusting device 18 starts to move the passenger module 14 fully automatically from the storing position in the storage chamber 16 (FIG. 4 on the right) into the operating position in front of the vehicle occupant (FIG. 5).

For this purpose, initially the door 30 of the storage chamber 16 is opened and the passenger module 14 is moved vertically, in parallel to the linear rail 44, upwards by the spindle drive 40, until the passenger module 14 has completely left the storage chamber 16.

After that, the rotation unit 42 pivots the passenger module 14 by approx. 90° about the axis of rotation A toward the vehicle occupant, and the passenger module 14 engages by the locking button 50 in the module holder 48.

Then the passenger module 14 can be further pivoted about the axis of rotation B to the desired position.

In order to adjust the passenger module 14 to the storing position again, the vehicle occupant activates the corresponding instruction on the operating panel 38.

Then the passenger module 14 is unlatched from the module holder 48 and is adjusted by the rotation unit 42 so that the surface including the multimedia panel 32 is aligned in parallel to the lateral face 46 of the center console 28. Subsequently, the passenger module 14 is moved vertically downwards in parallel to and along the linear rail 44 by the spindle drive 40, until the passenger module 14 is located completely inside the storage chamber 16. Then the door 30 of the storage chamber 16 is closed.

In the illustrated embodiment, the passenger module 14 is adjusted fully automatically via the spindle drive 40 and the rotation unit 42. It is also conceivable, however, that the adjustment is carried out manually by the vehicle occupant or that certain steps are run fully automatically and some steps are performed manually.

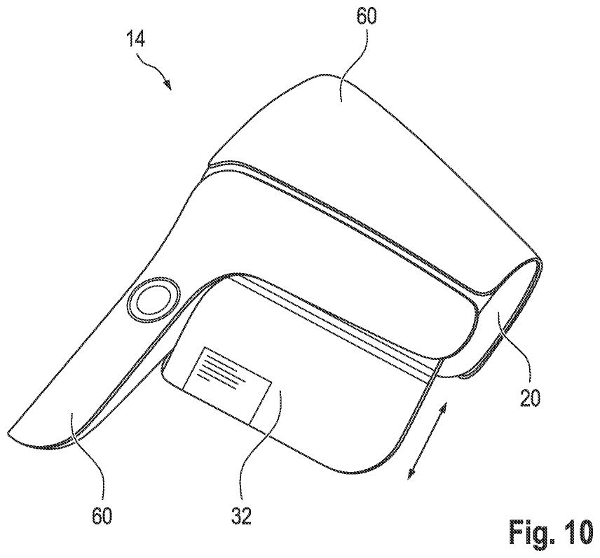

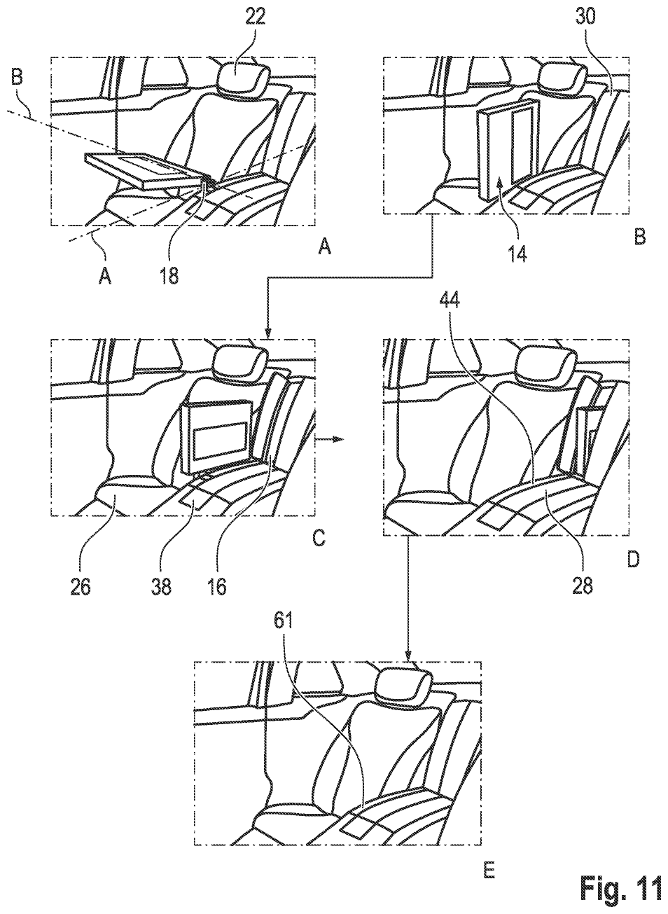

FIG. 11 illustrates a second embodiment of the hinged table system according to the invention. For the components known from the first embodiment, the same reference numerals are used, and in this respect the foregoing explanations are referred to.

The basic principle of the second embodiment corresponds to that of the first embodiment. Therefore, only the differences shall be explained in the following.

In the embodiment according to FIG. 11, the storage chamber 16 is disposed between two backrests 22 in a rear bench seat.

The door 30 is mounted to the front of the storage chamber 16 and extends mostly vertically. The passenger module 14 is moved in the longitudinal direction of the vehicle. FIG. 11 reveals in which way the passenger module 14 is adjusted from the operating position (FIG. 11A) to the storing position (FIG. 11E).

The holding and adjusting device 18 in this case includes a horizontal linear rail 44 for moving the passenger module 14 which is arranged on the center console 28.

In addition, a cover 61 which covers the linear rail 44 when the passenger module 14 is in the storing position is arranged at the linear rail 44. If the passenger module 14 is adjusted to the operating position, the cover 61 is retracted and the linear rail 44 is released.

The operating panel 38 in this embodiment is not covered by the door 30, when the passenger module 14 is in the storing position, as the operating panel 38 is disposed on the center console 28 between the seat bases 26.

When the passenger module 14 is adjusted from the operating position to the storing position, the passenger module 14 is pivoted by approx. 90° toward the center console 28 about the axis of rotation A (FIG. 11B). Then the passenger module 14 is pivoted by 90° about the axis of rotation B (FIG. 11C) and is moved horizontally, in parallel to the linear rail 44, into the storage chamber 16 (FIG. 11D), whereupon the door 30 of the storage chamber 16 is closed.

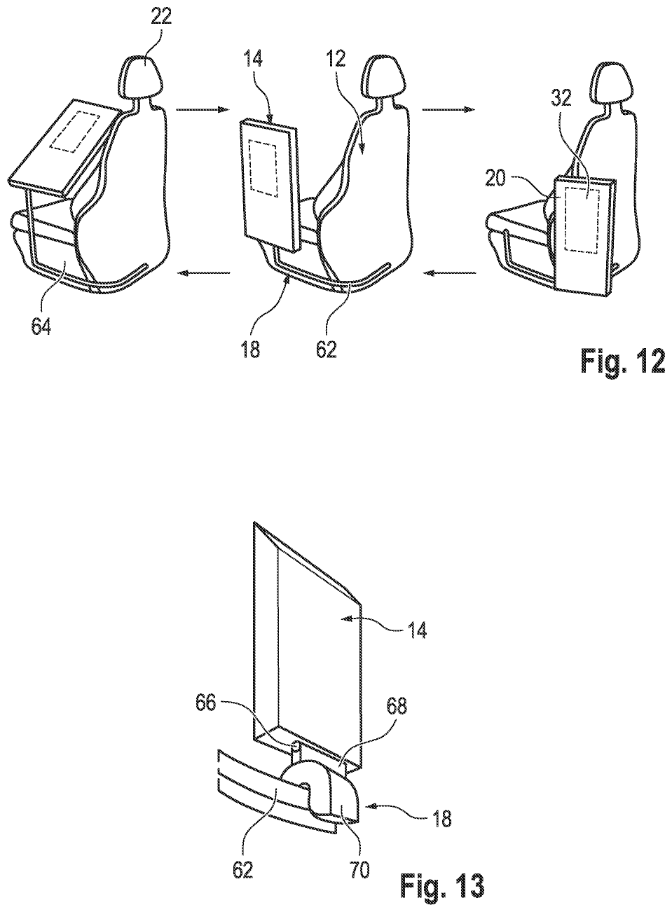

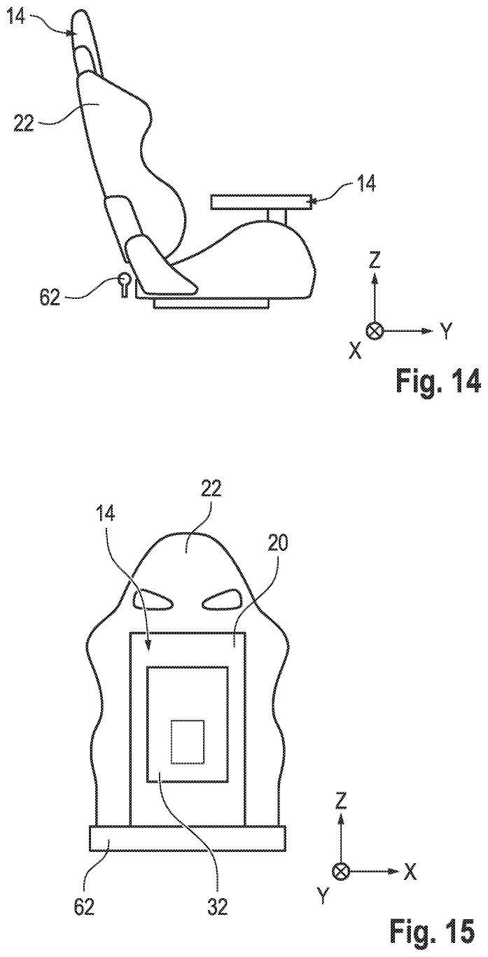

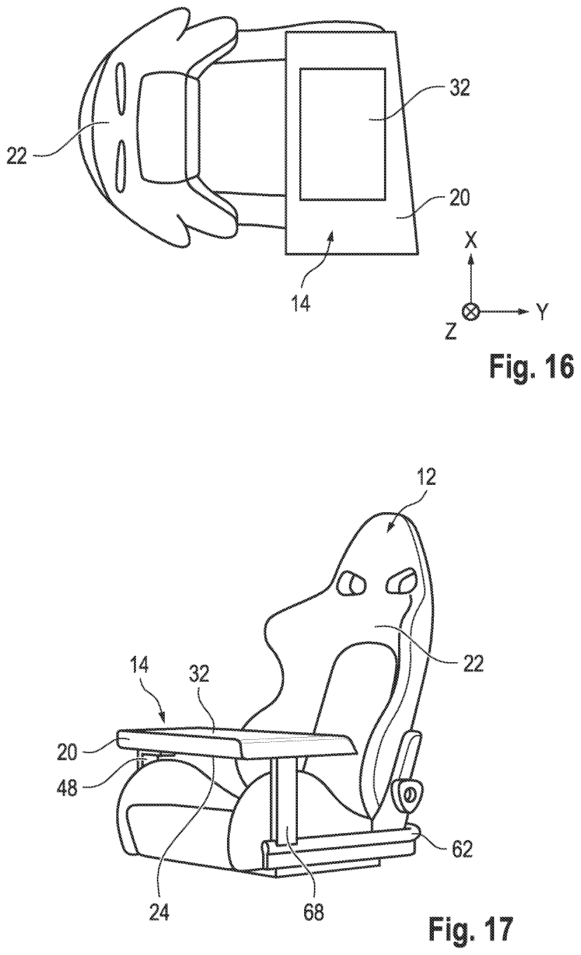

FIGS. 12 to 17 illustrate a third embodiment of the hinged table system according to the invention. For the components known from the first embodiment, the same reference numerals are used, and in this respect the above explanations are referred to.

The basic principle corresponds to that of the first embodiment. Therefore, only the differences shall be explained in the following.

The passenger module 14 in this case is arranged in the storing position at the backrest 22 of the vehicle seat 12. Accordingly, the passenger module 14 can be arranged, e.g., in a holder in the backrest 22 and/or can form a part of the backrest 22.

In the illustrated embodiment, the passenger module 14 is arranged vertically in the storing position and is positioned so that vehicle occupants sitting on a rear bench seat and facing the backrest 22 can use the multimedia panel 32 of the passenger module 14 as a screen.

The holding and adjusting device 18 includes a round guide rail 62 which is mounted on the vehicle seat 12 and predetermines an adjusting path for the passenger module 14.

Accordingly, the guide rail 62 extends laterally at the lower portion of the vehicle seat 12 from the backrest 22 laterally over the seat base 64 and shows a 90° curve at the transition from the backrest 22 to the seat base 64.

The passenger module 14 is rotatably connected to a lifting column 68 of the holding and adjusting device 18 via a joint 66 designed as a ball joint here.

The lifting column 68 serves for vertically moving the passenger module 14 and, in the illustrated embodiment, is slidably connected to the guide rail 62 via a U-shaped carriage 70. The lifting column 68 may be e.g. a telescopic arm. The carriage 70 serves for horizontally shifting the passenger module 14.

When adjusting the passenger module 14 from the storing position at the backrest 22 to the operating position in front of the vehicle occupant, the passenger module 14 is shifted via the carriage 70 on the guide rail 62. As soon as the carriage 70 has stopped in the end portion of the guide rail 62, the lifting column 68 adjusts the passenger module 14 upwards in the Z-axis. After that, the passenger module is pivoted via the joint 66 to the operating position.

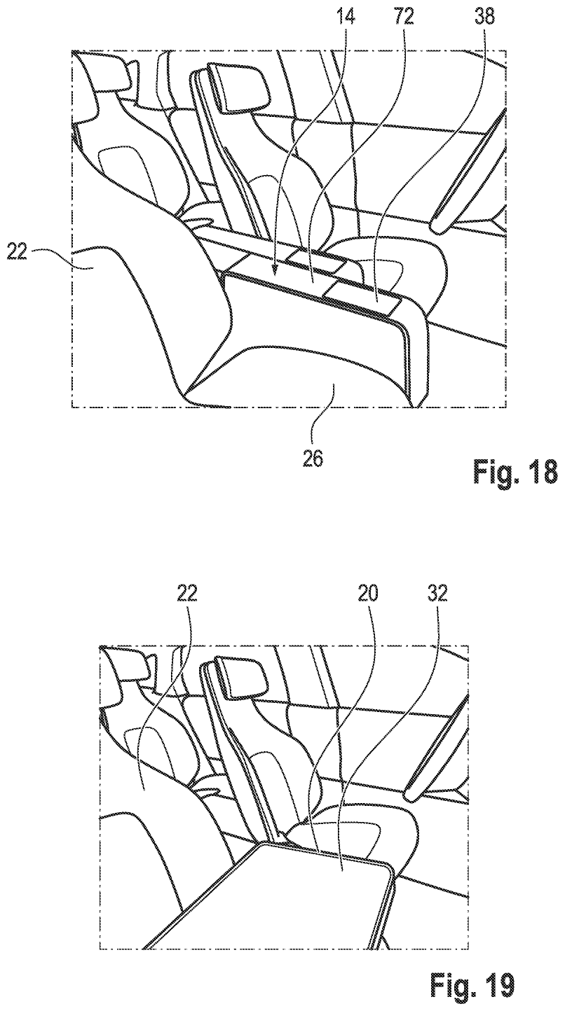

FIGS. 18 to 21 illustrate a first alternative embodiment of the hinged table system 10 which does not fall within the scope of the claims. For the components known from the first embodiment, the same reference numerals are used and, in this respect, the above explanations are referred to.

The basic principle corresponds to that of the first embodiment according to the invention. Therefore, only the differences shall be explained in the following.

The hinged table system 10 according to FIGS. 18 to 21 includes no storage chamber 16, as in this case the passenger module 14 replaces the center console 28.

In the storing position, the passenger module 14 forms the center console and a lateral face 72 of the tabletop 20 can be used as an armrest or tray.

The operating panel 38 is appropriately arranged on the lateral face 72 of the tabletop 20, the tabletop 20 in the storing position being aligned so that the operating panel 38 is on the upper side and can be conveniently reached by the vehicle occupant.

The holding and adjusting device 18 is mounted laterally on the vehicle seat 12, particularly laterally on the backrest 22, and is in the form of a pivotable telescopic arm 74 having a linear drive.

In the storing position, the telescopic arm 74 is aligned vertically, in other words in the Z-axis, and the passenger module 14 forms a center console or an armrest.

If the passenger module 14 shall be adjusted from the storing position to the operating position, the telescopic arm 74 pivots in parallel to the lateral face of the vehicle seat 12 and/or in parallel to the Y-Z plane upwards by approx. 90° and extends the portion to which the passenger module 14 is fastened.

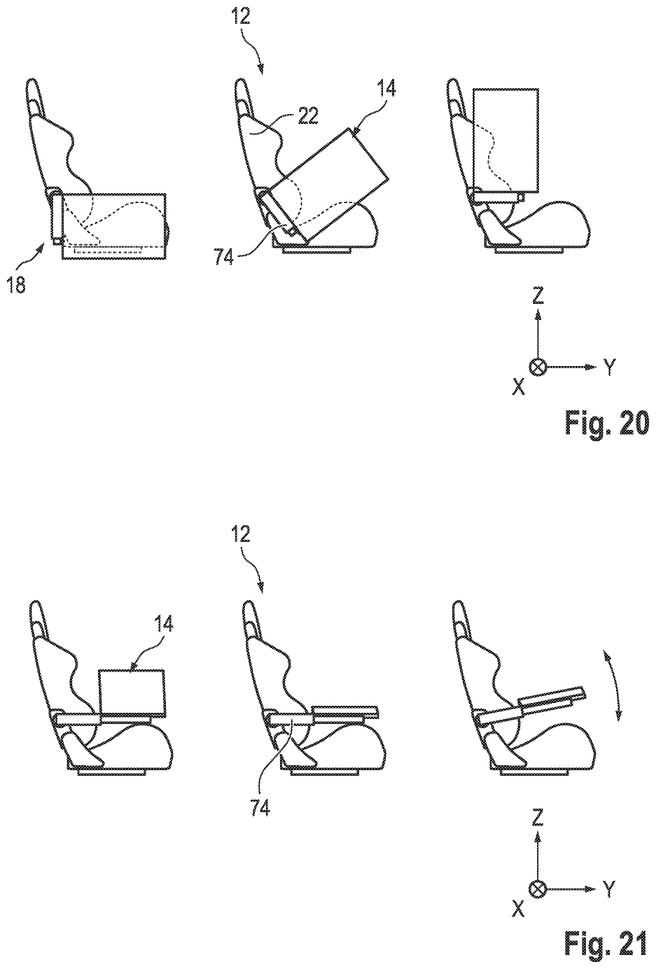

Subsequently, the passenger module 14 is pivoted by the extended portion of the telescopic arm 74 by approx. 90° toward the vehicle occupant about the axis of rotation C into the operating position (FIGS. 20 and 21).

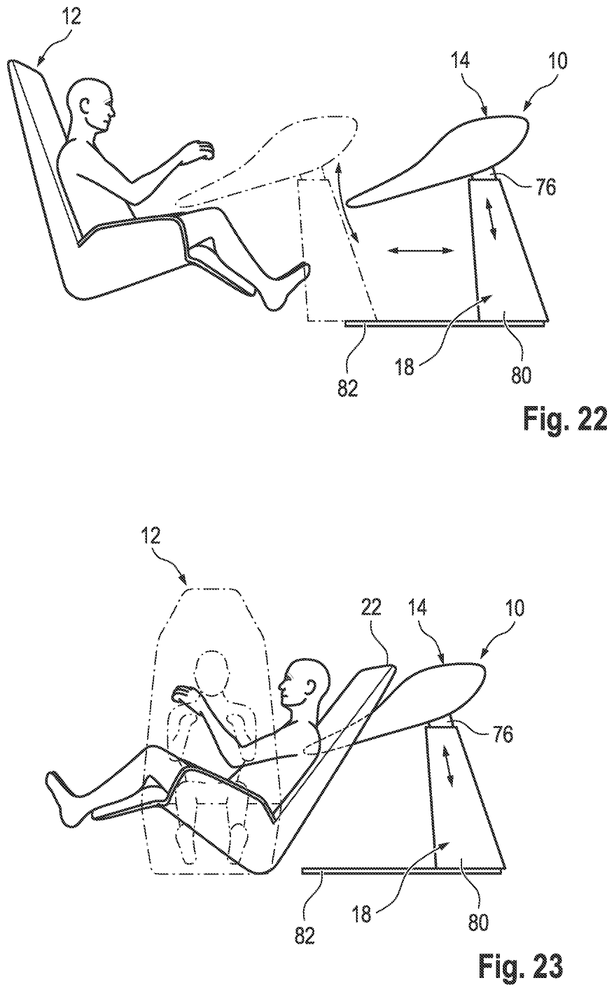

In FIGS. 22 and 23, a second alternative embodiment of the hinged table system is shown which is does not fall within the scope of the claims. For the components known from the first embodiment, the same reference numerals are used and, in this respect, the above explanations are referred to.

The hinged table system 10 according to FIG. 22 is completely separate from the vehicle seat 12. The passenger module 14 is rotatably connected to a lifting rail 76 via a joint.

The lifting rail 76 can vertically adjust the passenger module 14 and the passenger module 14 can be pivoted relative to the lifting rail 76 via the joint so that the position of the passenger module 14 can be adapted to the vehicle occupant.

The horizontal movement of the passenger module 14 is facilitated via a guide 82 in the vehicle floor which is slidably connected to a base member 80 of the holding and adjusting device 18.

The passenger module 14 is coupled to the base member 80 via the lifting rail 76.

In the storing position, the passenger module 14 is arranged remote from the vehicle occupant, for example like an instrument panel. For adjusting to the operating position, the passenger module 14 is moved in parallel to the guide 82 toward the vehicle occupant until the operating position is reached.

As is shown in FIG. 20, the vehicle seat 12 is rotatably coupled to the vehicle floor so that the vehicle seat 12 is aligned with the backrest 22 towards the passenger module 14 and the vehicle occupant is accommodated in the vehicle with the viewing direction away from the passenger module 14. This can be of advantage if the vehicle occupant is a pregnant person.

1. A hinged table system for a vehicle seat comprising a passenger module, a holding and adjusting device and a separate storage chamber, wherein the passenger module comprises at least an airbag and a tabletop including a multimedia panel (32), and the airbag is in fluid communication with an inflator so that the inflator can inflate the airbag, and wherein the passenger module is coupled to the holding and adjusting device and can be adjusted between an operating position in front of an associated vehicle occupant sitting in the vehicle seat and a storing position in the storage chamber.

2. The hinged table system according to claim 1, wherein the storage chamber includes a door which can be opened and closed.

3. The hinged table system according to claim 1, wherein an operating panel for controlling the holding and adjusting device is disposed in a center console.

4. The hinged table system according to claim 1, wherein the holding and adjusting device includes a linear rail for vertically and/or horizontally guiding the movement.

5. The hinged table system according to claim 1, wherein the holding and adjusting device includes a lifting mechanism with a spindle drive for vertically moving the passenger module.

6. The hinged table system according to claim 1, wherein the holding and adjusting device includes a rotation unit so that the passenger module can be pivoted about an axis of rotation.

7. The hinged table system according to claim 1, wherein the storage chamber is formed in the center console.

8. The hinged table system according to claim 1, wherein the storage chamber is disposed between two backrests.

9. A hinged table system for a vehicle seat comprising a passenger module and a holding and adjusting device, wherein the passenger module comprises at least an airbag and a tabletop including a multimedia panel, and the airbag is in fluid communication with an inflator so that the inflator can inflate the airbag, and wherein the passenger module is coupled to the holding and adjusting device and the holding and adjusting device includes a guide rail associated with the vehicle seat to predetermine an adjusting path for the passenger module, wherein the passenger module can be adjusted between an operating position in front of a vehicle occupant and a storing position at or in a backrest of the vehicle seat on the predetermined adjusting path.

10. The hinged table system according to claim 9, wherein the holding and adjusting device includes a lifting column for vertically moving the passenger module.

11. The hinged table system according to claim 10, wherein the holding and adjusting device includes a carriage, specifically a U-shaped carriage, which is slidably arranged on the guide rail, wherein the lifting column is mounted on the carriage.

12. The hinged table system according to claim 9, wherein the holding and adjusting device includes a joint for rotationally moving the passenger module.

13. The hinged table system according to claim 9, wherein the guide rail is mounted in a lower portion of a seat base of the vehicle seat.

14. The hinged table system according to claim 9, wherein the guide rail extends from one side of the vehicle seat to the back of the vehicle seat while showing a 90° curve.

15. The hinged table system according to claim 9, wherein the passenger module in the storing position is arranged at the backrest of the vehicle seat so that vehicle occupants sitting on a rear bench seat with a viewing direction to the backrest can use the multimedia panel as a screen.

16. The hinged table system according to claim 9, wherein the passenger module in the storing position is arranged in a holder in the backrest or forms a part of the backrest.

17. The hinged table system according to claim 1, wherein the hinged table system includes a module holder arranged on the vehicle seat, wherein the passenger module is coupled, on one side transversely to the longitudinal extension of the seat, to the holding and adjusting device and, on the opposite side, is releasably locked on the vehicle side in the operating position.

18. The hinged table system according to claim 1, wherein the module holder is designed on an armrest of the vehicle seat.

19. The hinged table system according to claim 1, wherein the holding and adjusting device (includes a drive for moving the passenger module fully automatically.

20. The hinged table system according to claim 1, wherein the passenger module is covered at least partly with an LED material.
